(19) United States
(12) Patent Application Publication
(10) Pub. No.: US 2013/0139887 A1
(43) Pub. Date: Jun. 6, 2013

(54) SCALABLE PRODUCTION OF DYE-SENSITIZED SOLAR CELLS USING INKJET PRINTING

(71) Applicants: Elias Stathatos, Patras (GR); Nicholas Kanopoulos, Thessaloniki (GR); Panagiotis Lianos, Aghios Vassilios Rion (GR); Yiannis Katsagounos, Itea-Kirra (GR); Theodore Makris, Patras (GR)

(72) Inventors: Elias Stathatos, Patras (GR); Nicholas Kanopoulos, Thessaloniki (GR); Panagiotis Lianos, Aghios Vassilios Rion (GR); Yiannis Katsagounos, Itea-Kirra (GR); Theodore Makris, Patras (GR)

(73) Assignee: BRITE HELLAS AE, Pylaia-Thessaloniki (GR)

(21) Appl. No.: 13/748,393

(22) Filed: Jan. 23, 2013

Related U.S. Application Data
(63) Continuation-in-part of application No. 12/986,181, filed on Jan. 7, 2011.

(51) Int. Cl. H01G 9/20

(52) U.S. Cl. CPC H01G 9/2018; H01G 9/20; H01G 9/2059
USPC 136/263; 156/145; 118/696

(57) ABSTRACT

Methods, systems, and apparatus regarding Dye Sensitized Solar Cells (DSSC) formed using nanocomposite organic-inorganic materials deposited by inkjet printing. Exemplary DSSC embodiments include long, narrow strips of titanium oxide and platinum inkjet-printed on fluorine-tin-oxide (FTO) conductive glass substrates. An exemplary deposition of organic materials may be made at ambient conditions, while the plate of printer where the FTO glass substrates were placed may be kept at 25° C. Exemplary FTO glass substrates with dimensions of about 1×1 m² may be covered with titanium oxide and platinum strips, while metal fingers of silver or other metal may be formed in between the strips to form separate solar cells. An electrolyte is added between two opposing, complementary electrode substrates to form one or more solar cells. A UV-blocking ink may be deposited to form a thin UV-blocking film on an outer side of the solar glass. Numerous other aspects are described.

### CROSS REFERENCE TO RELATED APPLICATIONS

This application is related to and claims the benefit of U.S. patent application Ser. No. 12/986,181 (“the '181 application”), titled “Quasi-Solid-State Photoelectrochemical Solar Cell Formed Using Inkjet Printing And Nanocomposite Organic-Inorganic Material,” and filed 7 Jan. 2011, which is related to and claimed the benefit of U.S. Provisional Patent Application Ser. No. 61/306,546 (“the '546 application”), titled “Photoelectrochemical Solar Cell Including Nanocomposite Organic-Inorganic Materials,” and filed 22 Feb. 2010, each of which is incorporated by reference herein in its entirety for all purposes.

### STATEMENT REGARDING SPONSORSHIP OF DEVELOPMENT

Aspects of the invention described herein are the result of development co-financed by Hellenic Funds and by the European Regional Development Fund (ERDF) under the Hellenic National Strategic Reference Framework (NSRF) 2007-2013, according to contract MICRO2-32 of the project “Development of Semitransparent Solar Panels” within the Program “Hellenic Technology Clusters in Microelectronics-Phase-2 Aid Measure.”

### BACKGROUND OF THE INVENTION

Solar panel technologies have used printing techniques for material deposition on glass, plastic, or metal substrates. For the third generation photovoltaics, and especially Dye Sensitized Solar Cells (“DSSC”) and Organic solar cells, printing methods are concentrated on the use of screen printing to achieve the solar cell product. Screen printing refers to the application of ink into the open areas of a patterned mask that is held over a substrate. The mask is then removed, and the substrate is baked at a relatively low temperature to evaporate the solvent of the ink. The baking process sets and solidifies the ink residue on the substrate. Screen printing may result in a considerable amount of wasted ink.

### BRIEF SUMMARY OF THE INVENTION

This invention includes systems and methods of producing solar cell modules using inkjet printing having a number of technical and cost advantages over screen printing. The invention allows for scaling the production line to printing on almost any size of substrate and at almost any production quantity.

The invention also includes a new ink suitable for inkjet printing to cover the outer side of the solar cell to reduce the ultraviolet (“UV”) irradiation entering the solar cell. Features of photocatalytic properties are also described.

In accordance with aspects of the invention, tooling for the production line for third generation photovoltaics, and in particular for Dye Sensitized Solar Cells, may be primarily composed of a series of inkjet print stations and thermal curing stations.

Each inkjet printing station may be stationary and include a number of print heads that are depositing different materials on the substrate. The number of print heads employed is a function of the maximum width of the substrate that the production line supports. Each print head may support a width of about 2 cm, and it can be installed with a variable number of nozzles for supporting different print speeds and amounts of deposited materials.

The substrate preferably moves under the print station at a speed that is proportional to the speed of material deposition supported by the print head. Based on this concept, the length of the substrate supported can be any size. The print heads preferably are digitally controlled, and therefore, substrates of any size can be supported, provided that their width is within the maximum width supported by the print station.

Located beyond the print station may be a thermal curing station, which may be implemented via an open oven section that can provide curing at variable temperatures. The substrate preferably will move through the curing station for as long as a curing step requires at a predetermined temperature. Alternatively, a thermal curing step could be performed in batch mode through the insertion of multiple substrates with materials deposited onto them by the inkjet printer into a large oven station, which cures them off-line. If multiple cycles of inkjet printing deposition and thermal curing are desired, a substrate may be conveyed backwards, or in a loop, to the printing station for performance of subsequent cycles.

The inspection of the substrates moving on the production line may be performed with an operator in the loop using a three-dimensional (3D) image of the substrates. The 3D image preferably is taken automatically by a common digital camera used at selected parts of the production line and preferably is displayed at the inspector's station in real time. The 3D image may be processed using machine vision techniques to compare the 3D image against an acceptable standard image for detection of unacceptable deviations from the standard. The system that performs the imaging process may be based on a 3D Manufacturing Inspector Tool developed by Brite™.

In accordance with further aspects of the invention, further embodiments of the invention may include:
A production line configuration, and method of configuring a production line, that allow material deposition on a substrate having a width up to a maximum width, and a variable, programmable length, wherein a plurality of print heads deposit material by firing in parallel to cover the width while the substrate is conveyed past the print heads that cover the length by sequential deposition over time.
An electric current collection conductive grid on a glass substrate surface, and a method of forming the same, formed by laser-scribing a channel, or trough, on the surface, the channel having a depth of a few microns, and filling the channel with silver conductive ink.
An inkjet-printable formulation of titanium-based ink that results in a TiO₂ film, and a method of formulating the titanium-based inkjet-printable ink.
An inkjet-printable formulation of titanium-based ink that results in a CeO₂—TiO₂-based UV-blocking material film, and a method of formulating the titanium-based inkjet printable ink.
An inkjet-printable formulation of silicon-based ink that results in an SiO₂-based insulating material film for conductive grid isolation, and a method of formulating silicon-based inkjet printable ink.
A quality inspection system of glass substrates on an inkjet-printing production line of photovoltaic panels, and a method of the quality inspection, using automated capture and display of three-dimensional images of the substrates in real-time.

### BRIEF DESCRIPTION OF THE DRAWINGS

By reference to the appended drawings, which illustrate exemplary embodiments of this invention according to aspects of the invention, the detailed description provided below explains in detail various features, advantages and aspects of this invention. As such, features of this invention can be more clearly understood from the following detailed description considered in conjunction with the following drawings. Each exemplary aspect or embodiment illustrated in the drawings is not intended to be to scale, to be comprehensive of all aspects, or to be limiting of the invention's scope, for the invention may admit to other equally effective embodiments and aspects.

FIGS. 1A-1B show cross-sectional side elevation views of exemplary embodiments of single- and dual-electrode substrate solar panels.

FIGS. 2A-2C show plan views of stages of formation of a first portion of an exemplary single-electrode substrate embodiment.

FIGS. 3A-3C show plan views of stages of formation of a second portion of an exemplary single-electrode substrate embodiment.

FIGS. 4A-4B show side elevation views of an assembly of a first portion and a second portion of an exemplary embodiment.

FIG. 5 shows a block-diagram plan view of an exemplary embodiment of a production line.

FIG. 6 shows a plan view of a first portion and a second portion side-by-side each other before being assembled of an exemplary dual-electrode substrate embodiment.

FIG. 7 depicts a graph of absorbance levels across a spectrum of wavelengths for a thin inkjet printed UV blocking layer on glass compared with absorbance levels for a common UV blocking plastic membrane.

### REFERENCE NUMERALS

The reference numerals denote the same or fundamentally similar elements throughout the drawings and detailed description.
A Single-Electrode Substrate Solar Panel 1000
a dye sensitized solar cell, 1010
a first portion 1020
a second portion 1030
a conductive substrate 1040 (single 1040S, dual 1040D, neg. 1040N, pos. 1040P)
a non-conductive surface 1050
a UV-blocking coating 1060, i.e., a deposit of a UV-blocking ink 1060
a conductive surface 1070
a negative conductive strip 1080, i.e., a deposit of a negative ink 1080
a negative strip separation width 1090
a conductive metal stripe 1100, i.e., a deposit of a metallic ink 1100
a trough 1110
a dielectric coating 1120, i.e., a deposit of a dielectric ink 1120
a photosensitizing dye 1130
a positive conductive strip 1140, i.e., a deposit of a positive ink 1140
a positive strip separation width 1150
a hole 1160
an electrolyte 1170
A Dual-Electrode Substrate Solar Panel 2000
a dual-electrode strip separation width 2010
A Production Line Configuration 500
a substrate conveyor 510
a substrate 520 suitable for use in a photovoltaic panel
an inkjet printing station 530, with a plurality of inkjet print heads 535
a curing station 540
a dyeing station 550
a substrate stacking and assembly station 560
an electrolyte filling station 570

### DETAILED DESCRIPTION

The invention relates to aspects of an inkjet printer production line for Dye-Sensitized Solar Cells Inkjet printing is a material-conserving deposition technique used for liquid inks comprising solutes dissolved in solvents Inkjet printing involves the ejection of precise amounts of ink from ink filled chambers housing a piezoelectric material and connected to nozzles. Application of a voltage causes the piezoelectric material to change shape, contracting the chamber. Contraction of the chamber sets up a micro-shockwave causing a liquid drop to be ejected from the nozzle. The ejected drop of ink falls onto the substrate under the applied forces of gravity and air resistance. The spreading of the ink along the surface is governed by the momentum acquired throughout the motion and surface tension present on the surface of the substrate.

In general, Dye-Sensitized Solar Cells (“DSSC”) comprise a dye-sensitized electrolyte in-between two conductive substrates. An exemplary electrically-conductive substrate comprises fluorine-doped tin oxide (“FTO”) coated glass, which is ideal for use in a wide range of devices, including applications such as opto-electronics, touch screen displays, thin film photovoltaics, energy-saving windows, radio-frequency interference (“RFI) or electromagnetic interference (“EMI”) shielding and other electro-optical and insulating applications. Fluorine-doped tin oxide has been recognized as a very promising material because it is relatively stable under atmospheric conditions, chemically inert, mechanically hard, high-temperature resistant, has a high tolerance to physical abrasion and is less expensive than indium tin oxide (“ITO”).

In the present invention, an exemplary substrate, such as an FTO glass substrate, is used with dye-sensitized inks that are jetted onto the substrate. A series of inkjet print stations can be used to speed up the process or separate the printing steps of the materials. A production line configuration may include inkjet print heads placed in fixed positions above a substrate conveyor, wherein the substrate moves on a moving conveyor at controlled speed. The material deposition may be digitally controlled by controlling the ink drop of the inkjet print heads.

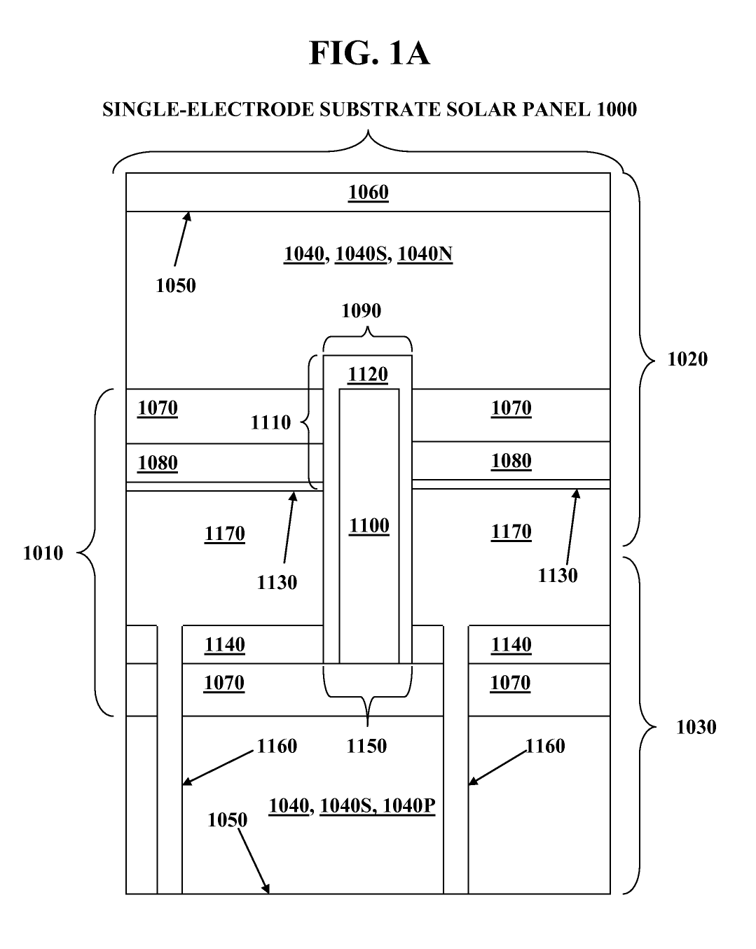

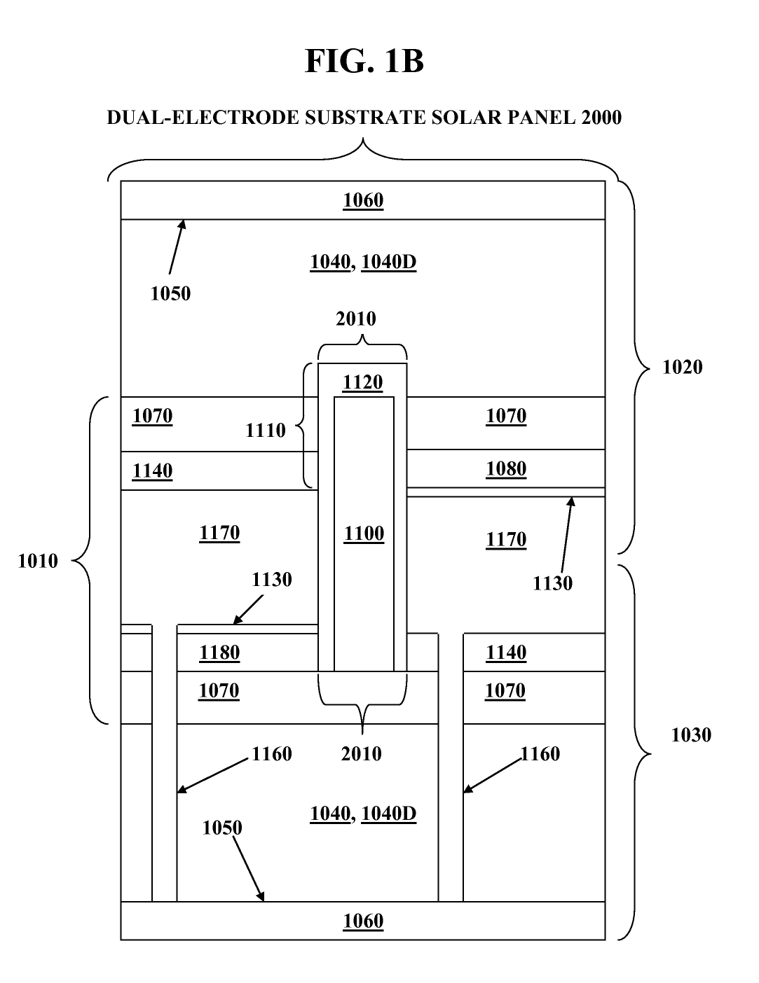

In the drawings, FIGS. 1A-1B show cross-sectional side elevation views of segments of substantially completed exemplary embodiments of a single-electrode substrate solar panel 1000 and a dual-electrode substrate solar panel 2000 according to aspects of the invention. The elements of the solar panels 1000 and 2000 are set forth in sequence above, and the manufacturing details for similar embodiments are set forth below.

Negative Electrode Substrate

Single-electrode conductive substrate panels 1000 using a DSSC 1010 comprise two portions, a first portion 1020 and a second portion 1030, each portion having an electrode per cell, one “negative” electrode and one “positive” electrode. In this context, ‘single-electrode’ substrate 1040S refers to the substrate having a single conductivity type (negative or positive) and not a sole electrode; it may have one or more physical electrodes, all of the same type. In contrast, a dual-electrode substrate 1040D has both negative and positive electrodes on it, and necessarily has at more than one physical electrode.

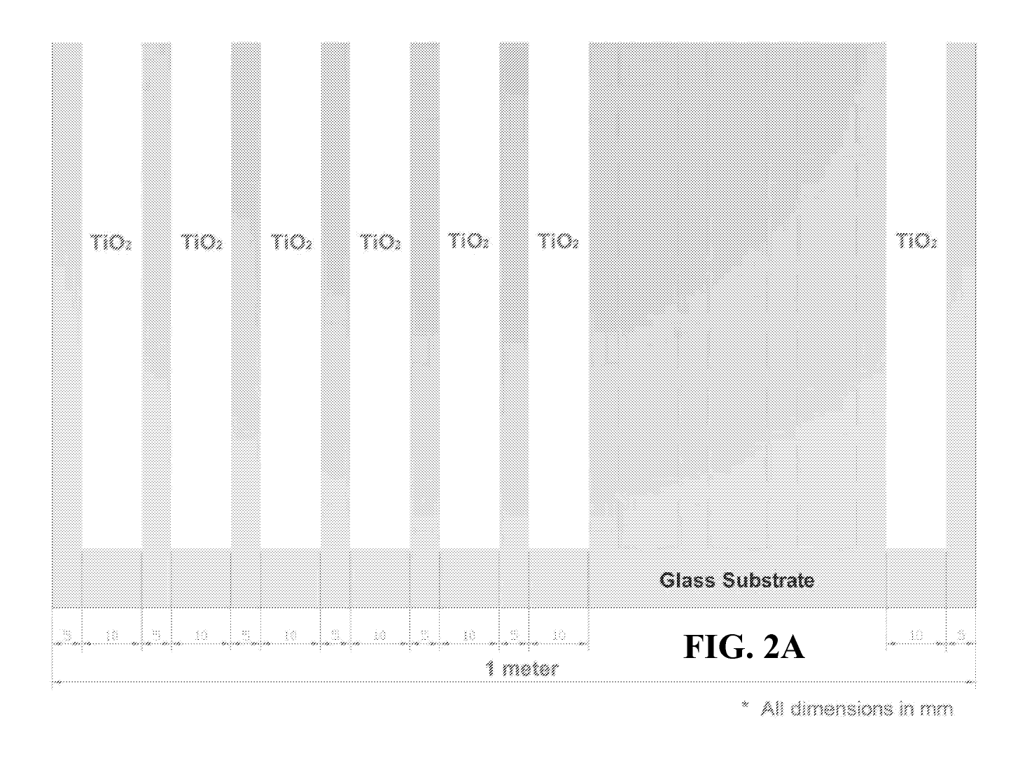

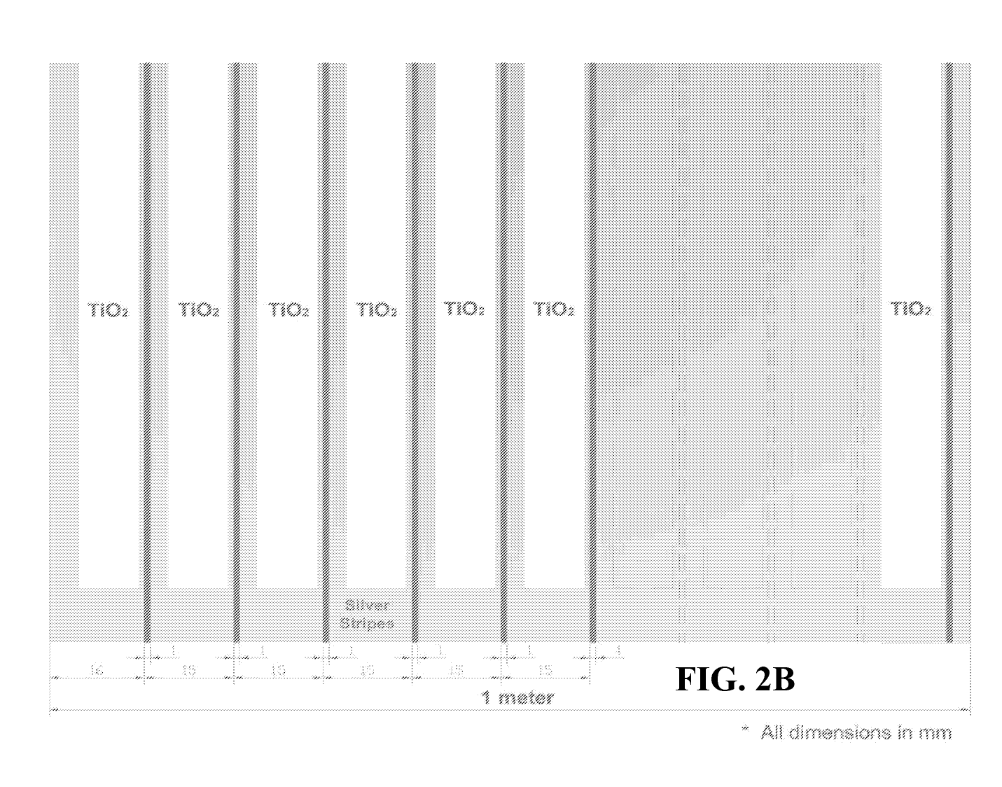

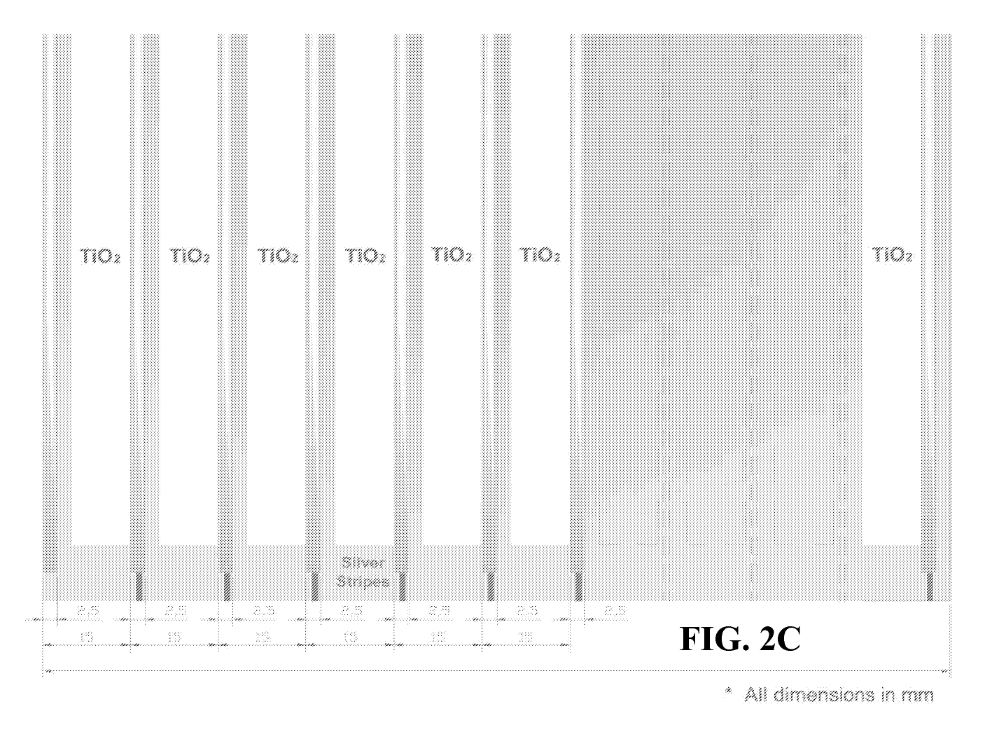

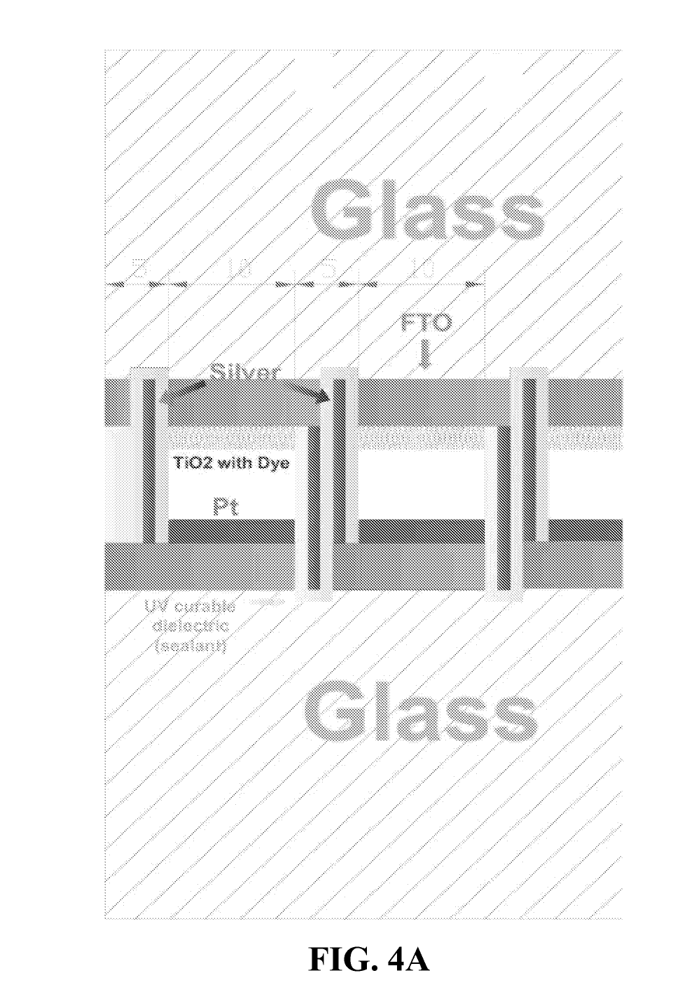

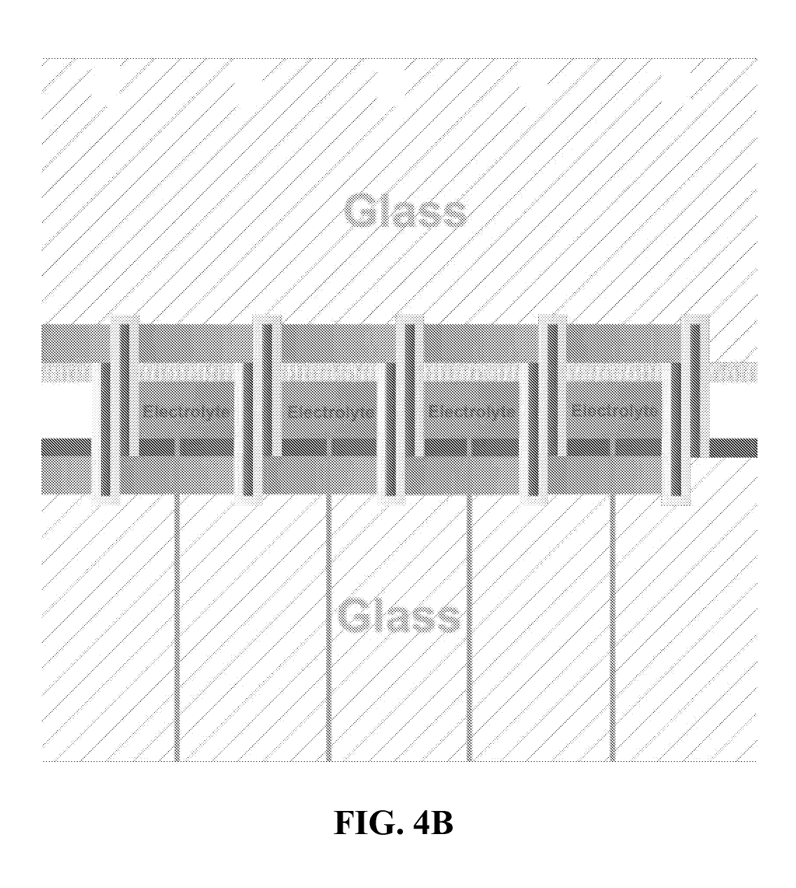

An exemplary first portion 1020 may comprise a single-electrode substrate 1040S having a plurality of negative electrodes (a negative electrode substrate 1040N), whereas an exemplary second portion 1030 may comprise a single-electrode substrate 1040S having a plurality of positive electrodes (a positive electrode substrate 1040P). Such a negative electrode substrate 1040N, shown in stages of manufacture in FIGS. 2A-2C of the cell, may comprise, for instance, a variety of inorganic nanocomposite oxides namely titanium dioxide (TiO₂), zinc oxide (ZnO), tin dioxide (SnO₂), etc. in the shape of long strips 1080. FIGS. 2A-2C show plan views of stages of manufacturing a FTO glass with successive TiO₂ strips 1080 (FIG. 2A) and silver metal fingers or stripes 1100 among them (FIG. 2B), all made with inkjet printing. In FIG. 2C, UV-curable insulating material 1120 has been inkjet printed to cover the portions of the silver fingers 1100 extending along the TiO₂ strips 1080. Although hard to see in FIG. 2C, laser scribing has been performed through the FTO film conductive surface 1070 on the FTO glass, which is more apparent in FIGS. 4A and 4B. Laser scribing may occur at an inkjet printing station 530, or at a separate station in a production line 500. The width of the TiO₂ strips 1080 may vary from 0.8 cm to 2 cm (8-20 mm), such as 10 mm in FIG. 2A. The length of the strips 1080 may also be varied from 10 cm to 100 cm (100-1000 mm). The strips 1080 are inkjet-printed using ink 1080 comprising nanoparticles of the appropriate metal oxides. Exemplary printing parameters as an example for TiO₂ are listed in Table 1.

TABLE 1
Exemplary printing parameters for TiO₂ ink

| Printing Parameters | values |
|---|---|
| T_{sub} (° C.) | 40 |
| T_{head} (° C.) | 25 |
| h_{cart} (mm) | 0.5 |
| Meniscus vacuum (inches) | 4.3 |
| Firing voltage (volts) | 20-21 |
| Overall pulse duration (μs) | 11.520 |
| Jetting frequency (kHz) | 5 |
| Drop spacing (μm) | 30 |

The printing procedure may be varied and repeated from 1 to 10 times depending on the composition of the ink 1080. Exemplary FTO glass substrates 1040N may be led to an oven 540 and subjected to a curing procedure lasting from 15 to 30 minutes at 450° C. to 550° C. depending on the metal oxide. The printing procedure may be repeated successive times, until the appropriate thickness of the films 1080 is obtained.

The space 1090 between metal oxide strips 1080 may vary from 2 mm to 5 mm. As shown in FIG. 2B, conductive metal stripes 1100, or “fingers,” of Silver, Copper, Molybdenum, Nickel, etc. can also be printed in-between the metal oxide strips 1080. In FIG. 2B, silver stripes 1100 are shown having widths of about 1 mm, but other widths are suitable, in relation to the widths selected for the TiO₂ strips 1080 and the distances 1090 between them. The thickness of metal layers of the stripes 1100 can be adjusted according to the number of times these films are printed. The overall printing procedure may be repeated several times. The glass substrates 1040N may be led to the oven 540 and cured using a curing procedure lasting from 15 to 30 minutes at 300° C. to 500° C. depending on the metal. Exemplary printing parameters as an example for a colloidal dispersion of silver nanoparticles are listed in Table 2.

TABLE 2
Exemplary printing parameters for silver metal fingers/stripes

| Printing Parameters | values |
|---|---|
| T_{sub} (° C.) | 30 |
| T_{head} (° C.) | 28 |
| h_{cart} (mm) | 0.250 |
| Meniscus vacuum (inches) | 4-5 |
| Firing voltage (volts) | 24 |
| Overall pulse duration (μs) | 11.76 |
| Jetting frequency (kHz) | 5 |
| Drop spacing (μm) | 30-35 |

As shown in FIG. 2C, the metal fingers 1100 finally may be covered with an insulating material 1120 using inkjet printing to form a lamination layer 1120. In particular, inks 1120 of dispersed plasticizers/plastics in different solvents such as polyimide, polycarbonates, etc., can be printed on metal fingers 1100 covering the total surface of the metal fingers 1100. The glass substrates 1040N may be led to the oven 540 and cured using a curing procedure lasting from 15 to 30 minutes at 300° C. to 400° C. depending on the polymer. Exemplary printing parameters as an example for polyimide are listed in Table 3.

TABLE 3
Exemplary printing parameters for polyimide insulating polymer

| Printing Parameters | values |
|---|---|
| T_{sub} (° C.) | 30 |
| T_{head} (° C.) | 35-40 |
| h_{cart} (mm) | 0.3 |
| Meniscus vacuum (inches) | 3.5 |
| Firing voltage (volts) | 20 |
| Overall pulse duration (μs) | 10.78 |
| Jetting frequency (kHz) | 5 |
| Drop spacing (μm) | 25 |

Instead of using thermally-cured insulating plastics for lamination of metal fingers 1100, the metal fingers 1100 may be covered with UV-cured insulating material 1120 applied with inkjet printing on metal fingers 1100 and stabilized during deposition with UV illumination. In particular, hexamethylene phenyl diacrylate/bis(2,4,6,-trimethylbenzoyl) phosphine oxide (HPD-TPO) and materials belonging to the family of diacrylates and phosphine oxides may be used as an insulating polymer and can be printed according to exemplary printing details described in Table 4. On the printer head 535, a fiber-optic filament may be mounted to illuminate the UV-curable insulating material 1120 with UV light coming from a UV light source with dose of 100-300 mJ/cm² in order to harden the UV-curable insulating material 1120.

TABLE 4
Exemplary printing parameters for an insulating polymer, using
hexamethylene phenyl diacrylate/bis (2,4,6,-trimethylbenzoyl)
phosphine oxide

| Printing Parameters | values |
|---|---|
| T_{sub} (° C.) | 22 (Room temperature) |
| T_{head} (° C.) | 50 |
| h_{cart} (mm) | 0.5 |
| Meniscus vacuum (inches) | 4.5 |
| Firing voltage (volts) | 22 |
| Overall pulse duration (μs) | 13.45 |
| Jetting frequency (kHz) | 1.5 |
| Drop spacing (μm) | 15 |

Another insulating option is to apply silicon dioxide (SiO₂) 1120 by inkjet printing. In particular, inkjet printing of silicon dioxide 1120 on metal fingers 1100 may use inks 1120 having appropriate compositions of tetramethoxysilane or triethoxysilane in an acidic isopropanol-water mixture and acetylacetonate. The ink 1120 can be printed according to exemplary printing details described in Table 5.

TABLE 5
Exemplary printing parameters for SiO₂ ink.

| Printing Parameters | values |
|---|---|
| T_{sub} (° C.) | 20-25 |
| T_{head} (° C.) | 25 |
| h_{cart} (mm) | 0.5 |
| Meniscus vacuum (inches) | 4.5 |
| Firing voltage (volts) | 18-20 |
| Overall pulse duration (μs) | 10.69 |
| Jetting frequency (kHz) | 3 |
| Drop spacing (μm) | 35 |

An exemplary preparation of a negative electrode may begin by providing a FTO glass substrate 1040 and forming parallel strips 1080 of TiO₂ on the FTO glass substrate 1040. An exemplary pattern of strips 1080 may include a first strip 1080 beginning 5 mm from the edge of glass, with a strip width of 8 mm to 20 mm and a strip spacing 1090 (edge to edge) of about 5 mm. FIG. 2A depicts a pattern for a few TiO₂ strips 1080, wherein this pattern is repeated along the width of the substrate 1040N, which preferably may be 0.2m to 1 m wide. Narrower or wider substrates may be used in accordance with their intended purposes and the maximum allowable dimensions of the assembly line 500. Upon formation of metal oxide strips 1080, the substrate 1040N may be thermally cured at about 500° C. to stabilize the TiO₂. These steps of forming and curing the metal oxide strips 1080 may be repeated several times to build a TiO₂ film thickness of preferably 2 to 4 microns.

The exemplary preparation of a negative electrode also may include forming several parallel silver fingers 1100 in the gaps 1090 between the TiO₂ strips 1080. The pattern repeats along the width (e.g., 0.2 m-1 m) of the substrate. The silver fingers 1100 may form a pattern in which a first metal finger 1100, or stripe, begins preferably 16 mm to 20 mm from the an edge of the glass substrate 1040, having a finger width of preferably 1 mm to 1.5 mm, and an exemplary finger spacing (edge to edge) of about 15 mm. FIG. 2B depicts an exemplary pattern for a few silver fingers 1100. The pattern is repeated along the width (e.g., 1 m) of the substrate 1040. Upon formation of the silver fingers 1100, the substrate 1040 may be thermally cured at about 300° C. to 500° C. to stabilize the silver fingers 1100. These steps of forming and curing the metal fingers 1100 may be repeated, e.g., 3 to 5 times, to build silver fingers 1100 having an exemplary thickness of about 20 to 30 microns. Greater thicknesses may require more repetitions of the printing and curing steps.

During the step resulting in the stage depicted in FIG. 2C, several parallel coatings 1120 may be formed of UV-curable dielectric material, polyimide, or SiO₂ ink 1120 onto previously printed silver stripes 1100 (one dielectric cover 1120 for each silver stripe 1100). The details of the formed pattern may be as follows: a first dielectric coating 1120 may begin directly from the left edge of the glass; coatings 1120 may have a width preferably of about 2.5 mm to 3.0 mm; and an exemplary spacing (edge to edge) may be about 15 mm. A UV light source may be used in order to achieve hardening of UV-curable insulating material 1120, whereas the substrate 1040 may be thermally cured at about 300° C. to 500° C. to stabilize polyimide or SiO₂ films 1120 on the silver fingers 1100.

After cooling, the glass substrate 1040N may be led to a dye tank 550 for dyeing of the strips 1080 of TiO₂ or other oxides. High purity dyes 1130 and a sealed environment for the dye adsorption preferably are used. The glass substrate 1040N may be stained for 1-12 hours depending on the dye 1130 being used. The dye 1130 comprises a photosensitizer, and exemplary photosensitizers include a ruthenium organometallic complex dye, a merocyanine dye, or a hemicyanine dye.

### Positive Electrode Substrate

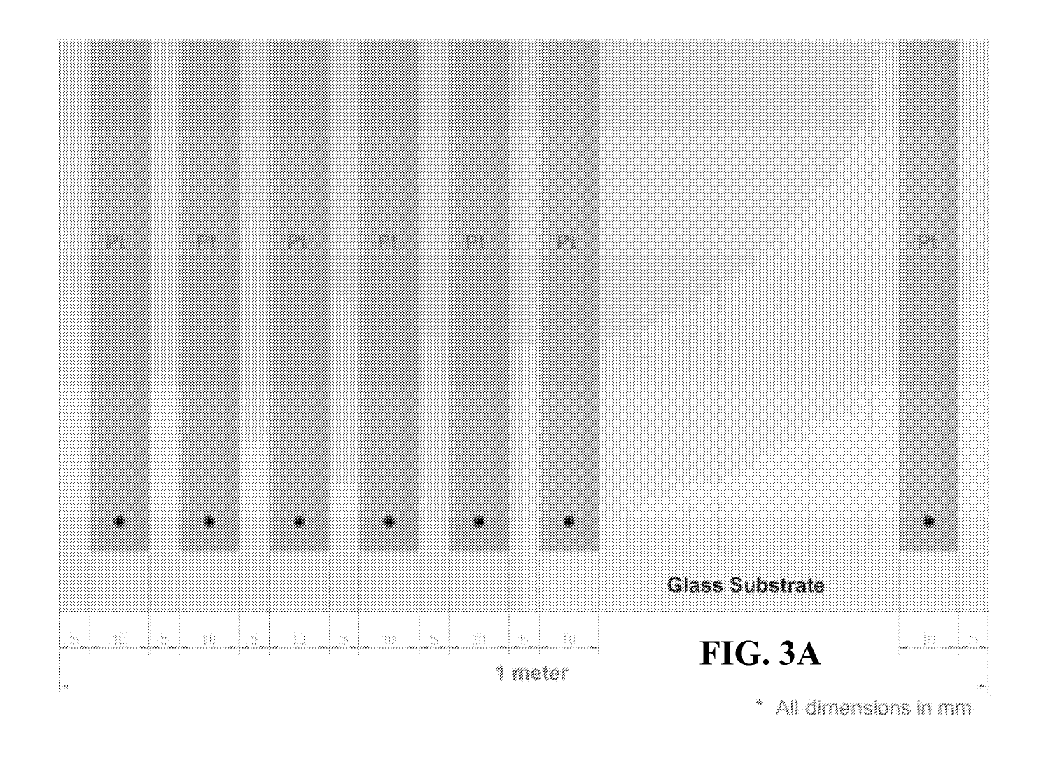

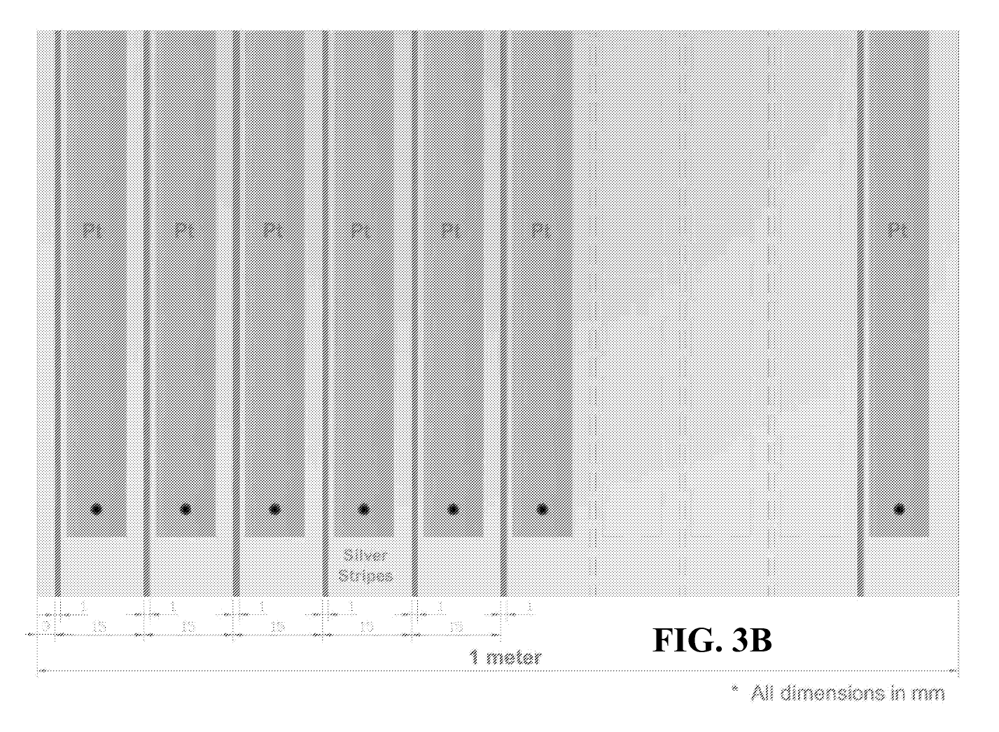

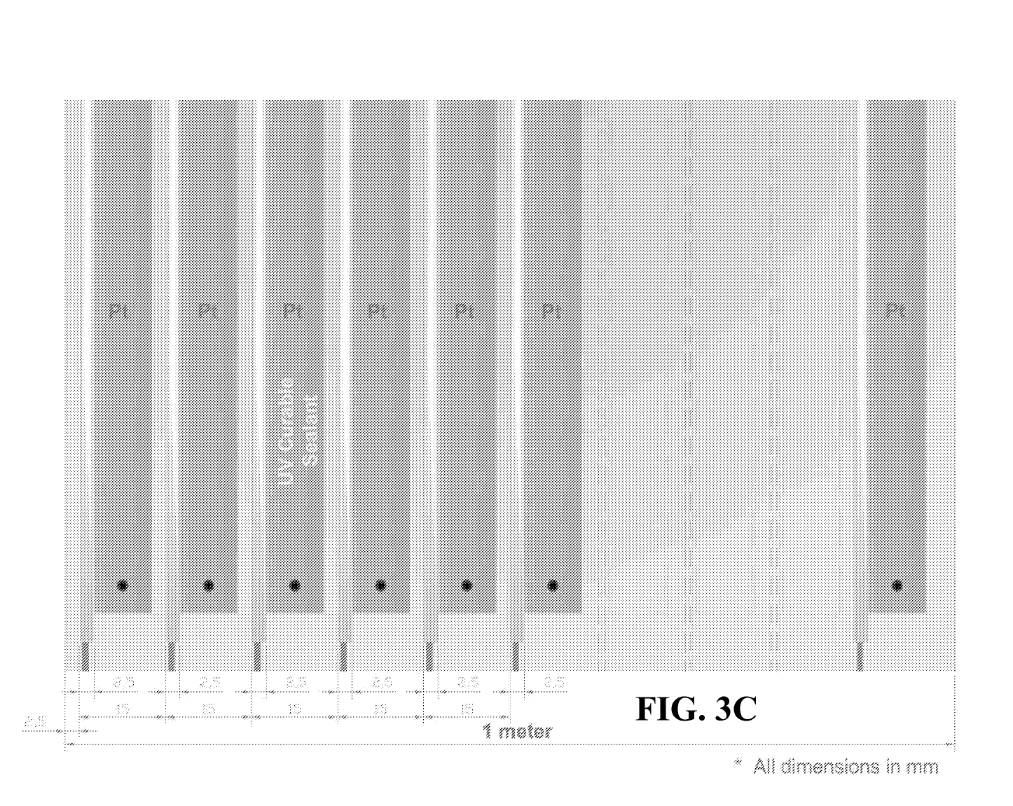

The second portion 1030 of a DSSC 1010 comprises a second substrate 1040 to oppose the first substrate 1040 comprising the first portion 1020. If the first portion 1020 is a negative electrode substrate 1040N, as in FIGS. 2A-2C, the second portion 1030 preferably is a positive electrode substrate 1040P, as in FIGS. 3A-3C. An exemplary positive electrode substrate 1040P comprises an electrocatalyst strip 1140, such as platinum (Pt) strips or conductive polymer strips on FTO glass 1040. Exemplary suitable electrocatalysts 1140 comprise platinum, carbon, and conjugated conductive polymers, or a mixture thereof, in the form of nanoparticles, nanotubes, or a mixture thereof. FIGS. 3A-3C show plan views of stages of manufacturing an FTO glass 1040P with successive platinum strips 1140 and silver metal fingers 1100 among them, all made with inkjet printing. Laser scribing preferably has been performed in the FTO film 1070 on the FTO glass 1040 after the stage shown in FIG. 3B. As shown in FIG. 3C, UV-curable insulating material 1120 has been inkjet printed to cover portions of the silver fingers 1100 adjacent the platinum strips 1140. In FIGS. 3A to 3C, black spots represent the holes 1160 through which an electrolyte 1170 will be filled in a cell 1010 formed by the gaps between the negative and positive electrode strips 1080, 1140.

The platinum or conductive polymer strips 1140 are inkjet printed using the appropriate inks 1140. Exemplary printing parameters for platinum are listed in Table 6.

TABLE 6
Printing parameters for platinum nanoparticles.

| Printing Parameters | values |
|---|---|
| T_{sub} (° C.) | 45 |
| T_{head} (° C.) | 22 (Room temperature) |
| h_{cart} (mm) | 0.5 |
| Meniscus vacuum (inches) | 3.5 |
| Firing voltage (volts) | 19-20 |
| Overall pulse duration (μs) | 13.23 |
| Jetting frequency (kHz) | 5 |
| Drop spacing (μm) | 25 |

The glass substrate 1040P may be led to the oven 540 to undergo an exemplary curing procedure lasting from 10 to 20 minutes at about 450° C., in case that platinum is used, while for polymers, an exemplary curing procedure lasts from 10 to 15 minutes at 100° C. The printing procedure may be repeated successive times until the desirable thickness of the films 1140 is achieved.

As with the negative electrode substrate 1040N, laser scribing through the FTO film 1070 on the FTO glass substrates 1040P, or any other suitable method, may be used to achieve electrical isolation between metal or metal oxide strips on both the negative and positive electrodes.

The details of the steps of FIGS. 3A-3C are as follows. During the step associated with FIG. 3A, several parallel strips 1140 of Platinum were formed on the glass substrate 1040. An exemplary formed pattern may include: a First Strip 1140 may begin about 16 mm to 20 mm from the left edge of the glass, having a strip width of about 1 mm to 1.5 mm, and a strip spacing 1150 (edge to edge) of about 15 mm. FIG. 3A depicts the pattern for a few strips 1140. The pattern may be repeated along the 0.2-1 m width of the substrate 1040P. Upon completion of step associated with FIG. 3A, the substrate may be thermally cured at 450° C. to stabilize the platinum.

During a step associated with FIG. 3B, several parallel stripes 1100, or fingers, of silver were formed in the gaps between the Platinum strips 1140. The silver fingers 1100 may form a pattern in which a first metal finger 1100 begins about 16 mm to 20 mm from the an edge of the glass substrate, having a finger width of about 1 mm to 1.5 mm, and a finger spacing (edge to edge) of about 15 mm. FIG. 3B depicts an exemplary pattern for a few silver fingers 1100. The pattern is repeated along the 0.2 m-1 m width of the substrate 1040P. Upon formation of the silver fingers 1100, the substrate 1040P may be thermally cured at about 300° C. to 500° C. to stabilize the silver fingers 1100. These steps of forming and curing the metal fingers 1100 may be repeated, e.g., 3 to 5 times, to build silver fingers 1100 having an exemplary thickness of about 20 to 30 microns. Greater thicknesses may require additional repetitions of the printing and curing steps.

During the step associated with FIG. 3C, several parallel strips of UV-curable dielectric material, polyimide, or SiO₂ ink 1120 are deposited onto the silver stripes 1100, one dielectric cover 1120 for each silver stripe 1100. An exemplary formed pattern may include: a first strip 1120 of dielectric material beginning directly from the left edge of the glass, having an exemplary strip width of about 2.5 mm to 3.0 mm, and an exemplary strip spacing (edge to edge) of about 15 mm. FIG. 3C depicts the pattern for only a few strips 1120. The pattern repeats along the width of the substrate. During step associated with FIG. 3C, UV light may be used to harden the UV material 1120, or the substrate may be thermally cured to between 300° C. and 500° C. to stabilize polyimide or SiO₂ films 1120 onto silver fingers 1100.

Preferably after the printing process, two holes 1160 may be drilled through the glass 1040 at both edges of each platinum strip 1140, as depicted in FIGS. 3A-3C by black dots. The holes 1160 are used to apply a vacuum at each strip in order to introduce an electrolyte 1170 (shown in FIG. 4B) and complete the cell 1010 as an individual solar cell 1010. Each hole 1160 preferably has a diameter of about 1 mm, such that the hole diameter does not present a problem when sealing the cell 1010.

Matching of Two Single-Electrode Substrates

An exemplary process of bringing together the negative and positive electrode substrates 1040N, 1040P is described in conjunction with FIGS. 4A and 4B, which illustrate the combination of two electrode substrates. FIGS. 4A-4B show side elevation views of a negative electrode substrate 1040N, comprising a FTO glass substrate 1040 with successive TiO₂ strips 1080, on top of a positive electrode substrate 1040P, comprising an FTO glass substrate 1040 with successive platinum strips 1140 opposite the TiO₂ strips 1080 to complete the solar cell 1010 in series connection. All strips are made with inkjet printing. Performance of laser scribing allows the dielectric-coated silver fingers 1100 extending from one electrode substrate 1040 to fit into scribed spaces 1110 in the FTO coating on the opposing electrode substrate 1040.

A purpose of the silver stripes with insulating material 1110 would be to separate the electrolyte 1170 of one solar cell 1010 (pair of opposing negative-positive electrodes) from the electrolyte 1170 of an adjacent solar cell 1010. In the case of two single-electrode substrates 1040S matched together, in theory the substrates need not be subdivided into multiple solar cells 1010, effectively making the two matched substrates a large, single solar cell 1010. Were the two matched single-electrode substrate 1040S pair to forego the laser-scribing and the silver fingers 1100, then the pair effectively would be a large, single solar cell 1010. In essence, the negative electrode substrate 1040N would function as a single negative electrode, and the positive electrode substrate 1040P would function as a single positive electrode, which also would allow for the deposition of the electrode material (e.g., TiO₂ and Pt) to cover the FTO surface of the substrate without being separated into strips 1080, 1140. In the event that the substrates were smaller already, this arrangement might be desirable and simplify manufacturing by eliminating the laser-scribing and silver finger formation steps. Furthermore, silver stripes 1100 may be formed on only one of two single-electrode substrates 1040S matched together, as opposed to on both, to reduce manufacturing steps, costs and time.

### Electrolyte Filling

During this step, the electrolyte 1170 is introduced between the two electrodes through the holes 1160 in one of the substrates, using a filling machine at an electrolyte filling station 570. FIG. 4B illustrates an exemplary stage of the electrolyte importation. In particular, FIG. 4B illustrates how the electrolyte 1170 is inserted in the space 1010 between the two glass substrates 1040. The two glass substrates 1040, having the two conductive sides 1070 on opposing interior surfaces, are placed such that the electrodes line up and face each other. The glass substrate edges may be sealed, for instance, with silicone rubber or epoxy resin, so vacuum could be formed in the space between them. As shown in FIGS. 4A-4B, the silver fingers 1100 from each FTO glass substrate 1040, for instance the negative electrode substrate 1040N, are formed in contact with the FTO layer 1070 and then extend slightly into the other glass substrate 1040, for instance the positive electrode substrate 1040P, after the opposing substrate was scribed with a laser. This procedure preferably is followed for all silver fingers 1100. The extension of the silver fingers into the opposing substrate forms a barrier from one cell to the next, and seals in the electrolyte 1170 within a given cell 1010. As mentioned above, the laser scribing also electrically separates each electrode from its adjacent neighboring electrodes. An exemplary depth of the laser scribed troughs 1110 can be varied from 0.5 mm to 1 mm, for example.

In an exemplary embodiment, two holes 1160 of about 1 mm in diameter are drilled with a precision drill at the two edges of any platinum strip 1140 as described above. A pressure differential may be applied at one or both of the holes, with electrolyte 1170 allowed to enter a hole 1160, drift to fill all the available free space and cover the surfaces of the electrodes.

Exemplary electrolytes 1160 include hybrid material Ureasil 230 (please see previous patent); a redox couple comprising iodine (I₂), potassium iodide (KI), and 1-methyl-3-propylimidazole iodide; 1 methylbenzimidazole; 2-amino-1-methylbenzimidazole; guanidine thiocyanate; and 4-tertiary butyl pyridine.

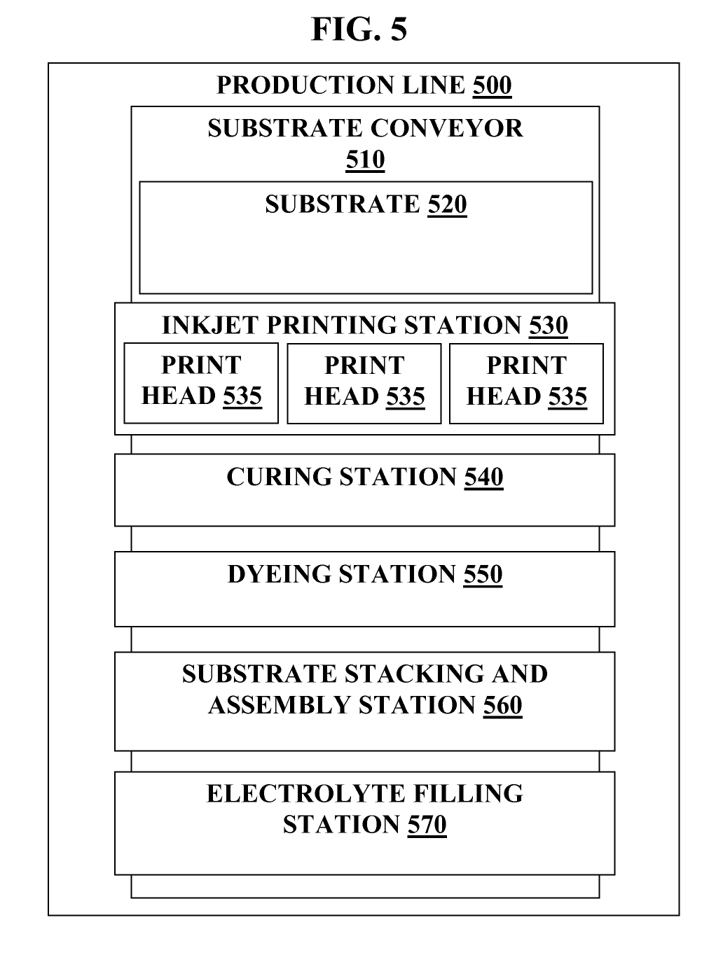

The steps of the processes described herein may be performed on an exemplary production line 500 for manufacture and assembly of the solar panels 1000, 2000. FIG. 5 shows a block-diagram plan view of an exemplary embodiment of a production line configuration 500, according to aspects of the invention. The production line 500 of FIG. 5 includes a substrate conveyor 510 that transports substrates 520 through the production line 500, which further includes an inkjet printing station 530, a curing station 540, a metal oxide dying station 550, a substrate stacking and assembly station 560, and an electrolyte filling station 570.

Dual-Electrode Substrates

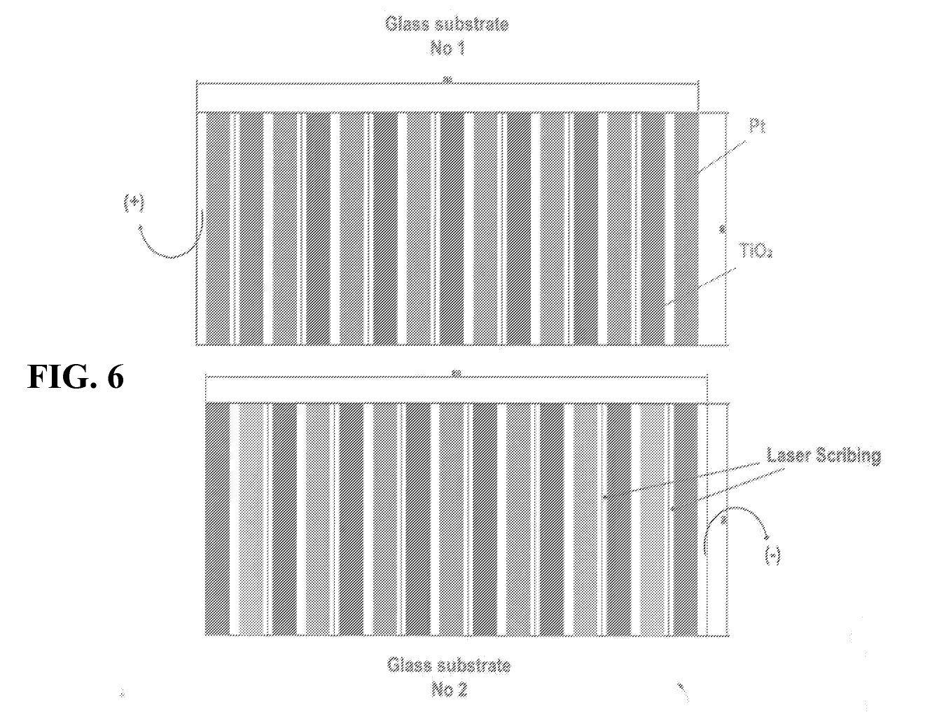

As an alternative to the structure exemplified in FIGS. 4A and 4B, in which the negative electrodes are on one FTO glass substrate 1040N, and the positive electrode are on an opposing FTO glass substrate 1040P, a further embodiment of the invention comprises substrates having alternating negative and positive electrodes that oppose complementary, oppositely-conducting electrodes when the substrates 1040D are brought together. Substrates 1040D having both negative and positive electrodes may be called dual-electrode substrates 1040D. FIG. 6 shows two dual-electrode FTO glass substrates 1040D with alternating strips of TiO₂ 1080 and platinum 1140 inkjet printed on the FTO glass substrates 1040D, with troughs 1110 laser-scribed in the FTO layers 1070 of the substrates 1040D. The laser scribing, or another suitable method, is used to electrically separate the metal oxide strips 1080 and platinum or conductive polymer strips 1140 used for a complete solar cell 1010.

The width of any polymer, metal or metal oxide strip can be varied from 0.8 cm to 2 cm. The length of the strips 1080, 1140 also may be varied from 10 cm to 100 cm. The strips 1080, 1140 are inkjet-printed using the appropriate ink formulation, e.g., metal oxide nanoparticles, platinum, or polymer. The printing procedure may be performed from 1 to 5 times depending on the composition of the ink 1080, 1140. The metal oxide nanoparticles preferably may be printed first, and the glasses 1040D may be led to the oven 540. A thermal curing process may last from 15 to 30 minutes at 450° C. to 550° C. depending on the metal oxide 1080. The printing procedure may be repeated for successive times until the appropriate thicknesses of the films 1080 are obtained.

The platinum or conductive polymer strips 1140 may be inkjet-printed besides the metal oxides 1080 using the appropriate inks 1140. The glasses 1040D then may be led to the oven 540. An exemplary curing procedure may last from 10 to 20 minutes at 450° C. in the case of platinum, while polymers may need an exemplary curing procedure lasting from 10 to 15 minutes at 100° C. The printing procedure may be repeated successive times until the desirable thicknesses of the films 1140 are achieved. The spaces 2010 between metal oxides strips 1080 and polymers or platinum strips 1140 preferably may vary from 2 mm to 5 mm.

Insofar as laser scribing is used to create troughs 1110 to electrically isolate pairs of electrodes, the dual-electrode substrates 1040D need not have as many laser-scribed troughs 1110 as needed for the single-electrode substrates 1040S. As shown in FIG. 6, an exemplary embodiment of the dual-electrode substrates 1040D has laser-scribed troughs 1110 alternating every other pair of negative and positive electrode strips 1080, 1140. In other words, when a pair of electrodes on the top substrate has a laser-scribed trough 1110, the opposing complementary pair of electrode on the bottom substrate does not have a laser-scribed trough 1110. This alternating pattern of laser-scribing allows the photovoltaic current to follow a path that resembles a square sine-wave across the dual-electrode substrate 1040D, going from left to right or right to left, however the electrode pairs are arranged.

Similarly, the use of silver stripes 1100 or fingers may be reduced with the use of dual-electrode substrates 1040D. For instance, silver stripes 1100 may be formed on the dual-electrode substrate 1040D between a positive electrode strip 1140 and a negative electrode strip 1080 opposite a laser-scribed trough 1110 on the opposing, complementary dual-electrode substrate 1040D. This pattern effectively reduces the number of silver stripes 1100 of a pair of dual-electrode substrates 1040D to one half of number of silver stripes 1100 of a pair of single-electrode substrates 1040S shown in FIGS. 4A and 4B. Half as many silver stripes 1100 would be needed because only half as many electrical isolations would be performed by laser scribing. A purpose of the silver stripes 1100 would be to separate the electrolyte 1170 of one solar cell 1010 (pair of opposing negative-positive electrodes) from the electrolyte 1170 of an adjacent solar cell 1010. In contrast to the matching of single-electrode substrates 1040S, which may forego the use of laser-scribed troughs 1110 and silver fingers 1100 to create multiple solar cells 1010 across a matched pair of substrates 1040S, as discussed above, the matching of dual-electrode substrates 1040D requires the subdivision of the dual-electrode substrates 1040D into multiple separated solar cells 1010 to control the path of any photovoltaic current generated.

After cooling, the dual-electrode glass substrates 1040D may be led to dye tanks at a dyeing station 550 for the dyeing of the strips 1080 of metal oxides. High purity dyes 1130 and a sealed environment for the dye adsorption preferably are used. The glasses 1040D may be stained for 1 to 12 hours depending on the dye 1130 used.

A similar procedure may be followed for creation of a second FTO glass dual-electrode substrate 1040D having offset negative and positive electrodes created by switching the locations of electrode strips in the sequence on the substrate 1040D. Once the second dual-electrode substrate 1040D is ready, the first and second dual-electrode substrates 1040D may be brought together, like the single-electrode substrates 1040S were in FIGS. 4A and 4B, to create sealed solar cells 1010 between the two dual-electrode substrates 1040D. Also as in the embodiment shown in FIGS. 4A and 4B, an electrolyte 1170 is necessary to finalize the solar cell 1010. The insertion of electrolyte 1170 between the two dual-electrode glass substrates 1040D may be achieved with an electrolyte filling machine 570 that generates a vacuum in a sealed cell 1010 and uses this pressure differential to introduce electrolyte 1170 into a cavity within the solar cell 1010.

Material Formulation for Inkjet Application and Printing Procedure.

Formation of an exemplary thin TiO₂ film 1080 on a transparent conductive glass substrate 1040 for use as a negative electrode may comprise, for instance, use of purely chemical processes through inkjet printing of a colloidal solution, in which, for example, controlled solvolysis and polymerization of titanium isopropoxide takes place. Another suitable alkoxide of the Titanium family may be used instead. For instance, in a premeasured volume of isopropanol, a premeasured quantity of a surfactant may be added. The surfactant may comprise the commercially available Triton X-100 [polyoxyethylene-(10) isooctylphenyl ether], another surfactant of the Triton family, or any other surfactant of any other category, preferably non-ionic, at a weight percentage that varies according to the chosen composition. An excess of commercially available acetic acid (“AcOH”) may be added, followed by addition of a premeasured volume of commercially available titanium isopropoxide, under vigorous stirring. A few drops of acetylacetonate or another β-diketonate are added to the previous mixture. This exemplary mixture eventually converts into a solid gel (e.g., a sol-gel process) through chemical reactions that lead to solvolysis and inorganic polymerization of titanium isopropoxide, or another alkoxide of the Titanium family that is, formation of —O—Ti—O-networks.

The platinum (Pt) layer 1140 may be formed by inkjet printing using, as ink 1140, hexachloroplatinic acid diluted in a premeasured mixture of terpineol, isopropanol, or other organic solvents, such as the Triton family. In some embodiments, a Pt layer 1140 may be very thin, such that the solar cell 1010 is transparent and may be used in solar windows. In other embodiments, the Pt layer 1140 may be deposited as a thick opaque reflective layer, so as to increase the probability of photon absorption by the photosensitizer 1130, which preferably is a dye 1130. In still another embodiment, a conductive polymer, for instance polypyrrole, (PEDOT:PSS), PEDOT may be used either in pure form or mixed with a small quantity of Pt. In all cases in which a transparent solar cell 1010 is desired, the exemplary electrocatalyst forms a transparent or semi-transparent film. In the aforementioned examples, materials can be deposited by inkjet printing.

Polymer insulating materials 1120 such as polyimide and other polymers in polyimides family may be directly printed by inkjet printing as well. Silver metal fingers 1100 may be inkjet printed using a silver colloidal solution as ink 1100 with variable 20% to 60% content of silver nanoparticles.

The inkjet printing station 530 may include a drop-on-demand (DOD) piezoelectric inkjet nozzle head 535 with 16 or more nozzles, depending on the printer, spaced at about 254 microns with typical drop sizes of between 1 and 10 picoliters. The print head 535 preferably is mounted onto a computer-controlled three-axis system capable of movement accuracy of 5 μm.

For printing of titanium dioxide strips 1080, as an example, the substrate temperature (T_{sub}) may be set at room temperature, while the temperature of the cartridge (T_{head}) may be set at about 28° C. The Cartridge Print Height (h_{cart}), which is the gap between the nozzle and the printed surfaces, may be about 0.5 mm or more during printing depending on the material. The ejection of the droplets may be performed using 16 to 128 nozzles by applying a firing voltage of 19 to 35 volts for an impulse having an overall pulse duration lasting at about 11.52 μs, at a jetting frequency of about 4 kHz. Optimal film uniformity may be achieved by printing at dot-to-dot spacing of 30 μm, known as drop spacing. Exemplary parameters followed for other inkjet printed materials appear in Tables 1, 2 and 3.

Material Formulation for Inkjet Printed UV-Blocking Film

Formation of an exemplary thin UV-blocking film 1060, such as a CeO₂—TiO₂ film 1060, on an outer, non-conductive side 1050 of the transparent conductive glass substrate 1040 (e.g., single-electrode substrate 1040S or dual-electrode substrate 1040D) may be made, for instance, by purely chemical processes by inkjet printing a colloidal solution, for example, in which controlled hydrolysis and polymerization of titanium isopropoxide, or another alkoxide of the Titanium family, takes place in presence of a rare earth Cerium (Ce) salt such as Cerium nitrate, or other salt of the cerium family. For instance, in a premeasured volume of ethanol, a premeasured quantity of a surfactant may be added. The surfactant may comprise the commercially available Triton X-100 [polyoxyethylene-(10) isooctylphenyl ether], another surfactant of the Triton family, or any other surfactant of any other category, preferably non-ionic, at a weight percentage that varies according to the chosen composition. An excess of commercially available acetic acid may be added, followed by addition of a premeasured volume of commercially available titanium isopropoxide, under vigorous stirring. A few drops of acetylacetonate or another β-diketonate may be added to the previous mixture. A premeasured quantity of cerium salt may be added at a relative composition of between 0.2M and 0.8M. Exemplary printing parameters for UV-blocking ink 1060 are listed in Table 7.

TABLE 7
Exemplary printing parameters for UV-blocking ink

| Printing Parameters | values |
|---|---|
| T_{sub} (° C.) | 22 (Room temperature) |
| T_{head} (° C.) | 25 |
| h_{cart} (mm) | 0.3 |
| Meniscus vacuum (inches) | 4 |
| Firing voltage (volts) | 22-23 |
| Overall pulse duration (μs) | 15.110 |
| Jetting frequency (kHz) | 1.5 |
| Drop spacing (μm) | 55 |

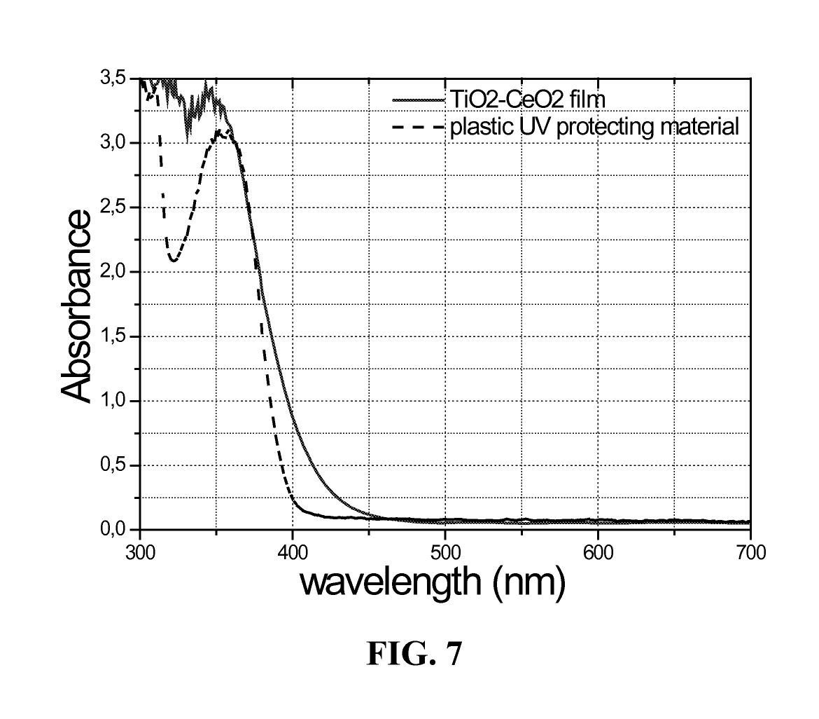

The pattern on the outer, non-conductive side 1050 of the glass can be few strips of UV-blocking material 1060 or, alternatively, the whole side could be covered with the material 1060. The procedure may be applied to part or all of the width (e.g., 0.5 m-1 m) of the substrate 1040. Upon completion of the printing procedure, the substrate may be thermally cured at about 500° C. to stabilize the CeO₂—TiO₂ films 1060. The absorbance of the resulting film 1060 can be seen on FIG. 7. In FIG. 7, absorbance levels of a thin inkjet-printed UV-blocking layer 1060 on glass 1040 is compared with absorbance levels of a common UV-blocking plastic membrane. Using inkjet printing, the above steps can be repeated several times to build a CeO₂—TiO₂ film 1060 having a thickness of about 0.2 to 1 micron, wherein different thicknesses have different levels of transparency, thinner films being more transparent than thicker films.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the invention will be readily apparent to those of ordinary skill in the art. Accordingly, other embodiments may fall within the spirit and scope of the invention, as defined by the following claims.

In the description above, numerous specific details are set forth in order to provide a more thorough understanding of embodiments of the invention. It will be apparent, however, to an artisan of ordinary skill that the invention may be practiced without incorporating all aspects of the specific details described herein. In other instances, specific details well known to those of ordinary skill in the art have not been described in detail so as not to obscure the invention. Readers should note that although examples of the invention are set forth herein, the claims, and the full scope of any equivalents, are what define the metes and bounds of the invention.

What is claimed is:

1. A method of forming a solar panel having a dye sensitized solar cell, the method comprising:
forming a first portion, forming the first portion comprising:
providing a first conductive substrate having a first conductive surface and a first non-conductive surface opposite the first conductive surface, the first conductive substrate being substantially planar and uniform in thickness;
forming a first negative conductive strip by inkjet printing on the first conductive surface, the first negative conductive strip adapted to function as a negative electrode of the solar cell;
dying the first negative conductive strip in a dying station having a photosensitizing dye;
forming a second portion, forming the second portion comprising:
providing a second conductive substrate having a second conductive surface and a second non-conductive surface opposite the second conductive surface, the second conductive substrate being substantially planar and uniform in thickness; wherein the second conductive substrate and the first conductive substrate are substantially equivalent in their dimensions;
forming a first positive conductive strip by inkjet printing on the second conductive surface, the first positive conductive strip adapted to function as a positive electrode of the solar cell;
stacking the first portion and the second portion on top of each other, such that the first conductive surface faces the second conductive surface, with the first and second non-conductive surfaces facing outward; and
disposing an electrolyte between the first and second conductive surfaces.

2. The method of claim 1, further comprising:
forming a second negative conductive strip by inkjet printing on the first conductive surface adjacent and parallel to the first negative conductive strip, the first and second negative conductive strips separated by a negative strip separation width; and
forming a second positive conductive strip by inkjet printing on the second conductive surface adjacent and parallel along the first positive conductive strip, the first and second positive conductive strips separated by a positive strip separation width;
wherein the second negative and second positive conductive strips are formed before stacking the first and second conductive substrates on top of each other.

3. The method of claim 2, further comprising:
forming a first conductive metal stripe by inkjet printing parallel to and between the first and second negative conductive strips;
forming a first trough through the first conductive surface by laser scribing parallel to and between the first and second negative conductive strips;
forming a second conductive metal stripe by inkjet printing parallel to and between the first and second positive conductive strips;
forming a second trough through the second conductive surface by laser scribing parallel to and between the first and second positive conductive strips; and
forming dielectric coatings by inkjet printing on the conductive metal stripes;
wherein the conductive metal stripes and the dielectric coatings are formed before stacking the first and second conductive substrates on top of each other; and
wherein stacking comprises aligning the conductive metal stripes with the troughs so that the conductive metal stripes oppose and extend into the troughs.

4. The method of claim 3, further comprising:
forming a first hole through the first negative conductive strip in a first alternative or the first positive conductive strip in a second alternative; and
forming a second hole through the second negative conductive strip in the first alternative or the second positive conductive strip in the second alternative;
wherein disposing the electrolyte comprises causing the electrolyte to traverse the first and second holes.

5. The method of claim 1, further comprising:
forming a second negative conductive strip by inkjet printing on the second conductive surface adjacent and parallel to the first positive conductive strip, the first positive and second negative conductive strips separated by a dual-electrode strip separation width; and
forming a second positive conductive strip by inkjet printing on the first conductive surface adjacent and parallel to the first negative conductive strip, the first negative and second positive conductive strips separated by the dual-electrode strip separation width;
wherein the second negative and second positive conductive strips are formed before stacking the first and second conductive substrates on top of each other.

6. The method of claim 5, further comprising:
forming a conductive metal stripe by inkjet printing parallel to and between the first negative and second positive conductive strips;
forming a trough through the second conductive surface by laser scribing parallel to and between the first positive and second negative conductive strips; and
forming a dielectric coating by inkjet printing on the conductive metal stripe;
wherein the conductive metal stripe and the dielectric coating are formed before stacking the first and second conductive substrates on top of each other; and
wherein stacking comprises aligning the conductive metal stripe with the trough so that the conductive metal stripe opposes and extends into the trough.

7. The method of claim 6, further comprising:
forming a first hole through the first negative conductive strip in a first alternative or the first positive conductive strip in a second alternative; and
forming a second hole through the second negative conductive strip in the first alternative or the second positive conductive strip in the second alternative;
wherein disposing the electrolyte comprises causing the electrolyte to traverse the first and second holes.

8. The method of claim 1, further comprising:
forming a conductive metal stripe by inkjet printing adjacent and parallel along the first negative conductive strip;
forming a trough through the first conductive surface by laser scribing adjacent and parallel along the conductive metal stripe; and
forming a dielectric coating by inkjet printing on the conductive metal stripe;
wherein the conductive metal stripe and the dielectric coating are formed before stacking the first and second conductive substrates on top of each other; and
wherein stacking comprises aligning the conductive metal stripe with the trough so that the conductive metal stripe opposes and extends into the trough.

9. The method of claim 8, further comprising:
forming a hole through the first negative conductive strip or the first positive conductive strip;
wherein disposing the electrolyte comprises causing the electrolyte to traverse the hole.

10. The method of claim 8, wherein:
forming the dielectric coating by inkjet printing comprises using a dielectric ink comprising plasticizers or plastics dispersed in a first solvent and adapted to be thermally cured, comprising an insulating material in a second solvent and adapted to be UV-cured; or comprising a silicon-based mixture adapted to be thermally cured.

11. The method of claim 10, wherein:
the dielectric ink comprising plasticizers or plastics dispersed in a first solvent and adapted to be thermally cured comprises a polyimide insulating polymer; and
inkjet printing parameters for the polyimide insulating polymer comprise:

| | |
|---|---|
| T_{sub} (° C.) | 30 |
| T_{head} (° C.) | 35-40 |
| h_{cart} (mm) | 0.3 |
| Meniscus vacuum (inches) | 3.5 |
| Firing voltage (volts) | 20 |
| Overall pulse duration (μs) | 10.78 |
| Jetting frequency (kHz) | 5 |
| Drop spacing (μm) | 25 |

12. The method of claim 10, wherein:
the dielectric ink comprising the insulating material in a second solvent and adapted to be UV-cured comprises hexamethylene phenyl diacrylate/bis(2,4,6,-trimethylbenzoyl) phosphine oxide; and
inkjet printing parameters for hexamethylene phenyl diacrylate/bis(2,4,6,-trimethylbenzoyl) phosphine oxide comprise:

| T_{sub} (° C.) | 22 (Room temperature) |
|---|---|
| T_{head} (° C.) | 50 |
| h_{cart} (mm) | 0.5 |
| Meniscus vacuum (inches) | 4.5 |
| Firing voltage (volts) | 22 |
| Overall pulse duration (μs) | 13.45 |
| Jetting frequency (kHz) | 1.5 |
| Drop spacing (μm) | 15 |

13. The method of claim 10, wherein:
the dielectric ink comprising the silicon-based mixture adapted to be thermally cured comprises tetramethoxysilane or triethoxysilane in an acidic isopropanol-water mixture and acetylacetonate; and
inkjet printing parameters for tetramethoxysilane or triethoxysilane in an acidic isopropanol-water mixture and acetylacetonate comprise:

| | |
|---|---|
| T_{sub} (° C.) | 20-25 |
| T_{head} (° C.) | 25 |
| h_{cart} (mm) | 0.5 |
| Meniscus vacuum (inches) | 4.5 |
| Firing voltage (volts) | 18-20 |
| Overall pulse duration (μs) | 10.69 |
| Jetting frequency (kHz) | 3 |
| Drop spacing (μm) | 35 |

14. The method of claim 8, wherein:
forming the conductive metal stripe by inkjet printing comprises using a metallic ink comprising a colloidal dispersion of silver nanoparticles; and
inkjet printing parameters for the colloidal dispersion of silver nanoparticles comprise:

| | |
|---|---|
| T_{sub} (° C.) | 30 |
| T_{head} (° C.) | 28 |
| h_{cart} (mm) | 0.250 |
| Meniscus vacuum (inches) | 4-5 |
| Firing voltage (volts) | 24 |
| Overall pulse duration (μs) | 11.76 |
| Jetting frequency (kHz) | 5 |
| Drop spacing (μm) | 30-35 |

15. The method of claim 1, wherein:
the first and second conductive surfaces comprise fluorine-doped tin oxide;
the first negative conductive strip comprises titanium dioxide;
the first positive conductive strip comprises platinum or a conductive polymer;
the dye comprises one of a ruthenium organometallic complex dye, a merocyanine dye, or a hemicyanine dye; and
the electrolyte comprises one of a redox couple comprising iodine (I₂), potassium iodide (KI), and 1-methyl-3-propylimidazole iodide; 1 methylbenzimidazole; 2-amino-1-methylbenzimidazole; guanidine thiocyanate; and 4-tertiary butyl pyridine.

16. The method of claim 15, wherein:
forming the first negative conductive strip by inkjet printing comprises using a negative ink comprising nanoparticles of titanium dioxide; and
forming the first positive conductive strip by inkjet printing comprises using a positive ink comprising nanoparticles of platinum.

17. The method of claim 16, wherein:
first inkjet printing parameters for the negative ink comprising nanoparticles of titanium dioxide comprise:

| | |
|---|---|
| T_{sub} (° C.) | 40 |
| T_{head} (° C.) | 25 |
| h_{cart} (mm) | 0.5 |
| Meniscus vacuum (inches) | 4.3 |
| Firing voltage (volts) | 20-21 |
| Overall pulse duration (μs) | 11.520 |
| Jetting frequency (kHz) | 5 |
| Drop spacing (μm) | 30 |

and
second inkjet printing parameters for the positive ink comprising nanoparticles of platinum comprise:

| | |
|---|---|
| T_{sub} (° C.) | 45 |
| T_{head} (° C.) | 22 (Room temperature) |
| h_{cart} (mm) | 0.5 |
| Meniscus vacuum (inches) | 3.5 |
| Firing voltage (volts) | 19-20 |
| Overall pulse duration (μs) | 13.23 |
| Jetting frequency (kHz) | 5 |
| Drop spacing (μm) | 25 |

18. The method of claim 1, further comprising:
forming a UV-blocking coating by inkjet printing on the first non-conductive surface, the second non-conductive surface, or both.

19. The method of claim 18, wherein:
the UV-blocking coating comprises a CeO₂—TiO₂ film having a thickness of about 0.2 to 1 micron.

20. The method of claim 19, wherein:
forming the CeO₂—TiO₂ film comprises using a UV-blocking ink comprising titanium isopropoxide mixed with cerium nitrate; and
inkjet printing parameters for the UV-blocking ink comprising titanium isopropoxide mixed with cerium nitrate comprise:

| T_{sub} (° C.) | 22 (Room temperature) |
|---|---|
| T_{head} (° C.) | 25 |
| h_{cart} (mm) | 0.3 |
| Meniscus vacuum (inches) | 4 |
| Firing voltage (volts) | 22-23 |
| Overall pulse duration (μs) | 15.110 |
| Jetting frequency (kHz) | 1.5 |
| Drop spacing (μm) | 55 |

21. A solar panel having a dye-sensitized solar cell comprising:
a first portion comprising:
a first conductive substrate having a first conductive surface and a first non-conductive surface opposite the first conductive surface, the first conductive substrate being substantially planar and uniform in thickness; and
a first negative conductive strip formed by inkjet printing on the first conductive surface, the first negative conductive strip adapted to function as a negative electrode of the solar cell, the first negative conductive strip having been dyed with a photosensitizing dye; and
a second portion comprising:
a second conductive substrate having a second conductive surface and a second non-conductive surface opposite the second conductive surface, the second conductive substrate being substantially planar and uniform in thickness; wherein the second conductive substrate and the first conductive substrate are substantially equivalent in their dimensions; and
a first positive conductive strip formed by inkjet printing on the second conductive surface, the first positive conductive strip adapted to function as a positive electrode of the solar cell;
wherein the first portion and the second portion are stacked on top of each other, such that the first conductive surface faces the second conductive surface, with the first and second non-conductive surfaces facing outward; and
wherein an electrolyte is disposed between the first and second conductive surfaces.

22. The solar panel of claim 21, further comprising:
a second negative conductive strip formed by inkjet printing on the first conductive surface adjacent and parallel to the first negative conductive strip, the first and second negative conductive strips separated by a negative strip separation width; and
a second positive conductive strip formed by inkjet printing on the second conductive surface adjacent and parallel along the first positive conductive strip, the first and second positive conductive strips separated by a positive strip separation width;
wherein the second negative and second positive conductive strips are formed before stacking the first and second conductive substrates on top of each other.

23. The solar panel of claim 22, further comprising:
a first conductive metal stripe formed by inkjet printing parallel to and between the first and second negative conductive strips;
a first trough through the first conductive surface formed by laser scribing parallel to and between the first and second negative conductive strips;
a second conductive metal stripe formed by inkjet printing parallel to and between the first and second positive conductive strips;
a second trough through the second conductive surface formed by laser scribing parallel to and between the first and second positive conductive strips; and
dielectric coatings formed on the conductive metal stripes;
wherein the conductive metal stripes and the dielectric coatings are formed before the first and second conductive substrates are stacked on top of each other; and
wherein the conductive metal stripes are aligned with the troughs so that the conductive metal stripes oppose and extend into the troughs.

24. The solar panel of claim 23, further comprising:
a first hole formed through the first negative conductive strip in a first alternative or the first positive conductive strip in a second alternative; and
a second hole formed through the second negative conductive strip in the first alternative or the second positive conductive strip in the second alternative;
wherein the electrolyte traverses the first and second holes.

25. The solar panel of claim 21, further comprising:
a second negative conductive strip formed by inkjet printing on the second conductive surface adjacent and parallel to the first positive conductive strip, the first positive and second negative conductive strips separated by a dual-electrode strip separation width; and
a second positive conductive strip formed by inkjet printing on the first conductive surface adjacent and parallel to the first negative conductive strip, the first negative and second positive conductive strips separated by the dual-electrode strip separation width;
wherein the second negative and second positive conductive strips are formed before stacking the first and second conductive substrates on top of each other.

26. The solar panel of claim 25, further comprising:
a conductive metal stripe formed by inkjet printing parallel to and between the first negative and second positive conductive strips;
a trough formed through the second conductive surface by laser scribing parallel to and between the first positive and second negative conductive strips; and
a dielectric coating formed on the conductive metal stripe;
wherein the conductive metal stripe and the dielectric coating are formed before stacking the first and second conductive substrates on top of each other; and
wherein the conductive metal stripe is aligned with the trough so that the conductive metal stripe opposes and extends into the trough.

27. The solar panel of claim 26, further comprising:
a first hole formed through the first negative conductive strip in a first alternative or the first positive conductive strip in a second alternative; and
a second hole formed through the second negative conductive strip in the first alternative or the second positive conductive strip in the second alternative;
wherein the electrolyte traverses the first and second holes.

28. The solar panel of claim 21, further comprising:
a conductive metal stripe formed by inkjet printing adjacent and parallel along the first negative conductive strip;
a trough formed through the first conductive surface by laser scribing adjacent and parallel along the conductive metal stripe; and
a dielectric coating formed on the conductive metal stripe;
wherein the conductive metal stripe and the dielectric coating are formed before stacking the first and second conductive substrates on top of each other; and
wherein the conductive metal stripe is aligned with the trough so that the conductive metal stripe opposes and extends into the trough when the first and second portions are stacked.

29. The solar panel of claim 28, wherein:
the conductive metal stripe comprises silver.

30. The solar panel of claim 28, further comprising:
a hole formed through the first negative conductive strip or the first positive conductive strip;
wherein the electrolyte traverses the hole.

31. The solar panel of claim 28, wherein:
the dielectric coating is formed using a dielectric ink comprising plasticizers or plastics dispersed in a first solvent and adapted to be thermally cured, comprising insulating material in a second solvent and adapted to be UV-cured; or comprising silicon-based mixture adapted to be thermally cured.

32. The solar panel of claim 21, wherein:
the first and second conductive surfaces comprise fluorine-doped tin oxide;
the first negative conductive strip comprises titanium dioxide;
the first positive conductive strip comprises platinum or a conductive polymer;
the dye comprises one of a ruthenium organometallic complex dye, a merocyanine dye, or a hemicyanine dye; and
the electrolyte comprises one of a redox couple comprising iodine (I₂), potassium iodide (KI), and 1-methyl-3-propylimidazole iodide; 1 methylbenzimidazole; 2-amino-1-methylbenzimidazole; guanidine thiocyanate; and 4-tertiary butyl pyridine.

33. The solar panel of claim 32, wherein:
the first negative conductive strip is formed using a negative ink comprising nanoparticles of titanium dioxide; and
the first positive conductive strip is formed using a positive ink comprising nanoparticles of platinum.

34. The solar panel of claim 21, further comprising:
a UV-blocking coating formed by inkjet printing on the first non-conductive surface, the second non-conductive surface, or both.

35. The solar panel of claim 34, wherein:
the UV-blocking coating comprises a CeO₂—TiO₂ film having a thickness of about 0.2 to 1 micron.

36. A system comprising a production line configuration, the system comprising:
a substrate conveyor adapted to convey a substrate suitable for use in a photovoltaic panel, wherein the substrate is conveyed by the substrate conveyor at a controlled, programmable speed;
a printing station having a plurality of inkjet print heads placed in fixed positions above the substrate conveyor, the printing station adapted to inkjet print conductive ink on the substrates passing below the print heads, wherein material deposition is digitally controlled by programming an ink drop of the inkjet print heads; and
a curing station arranged in-line with the substrate conveyor and adapted to cure the conductive ink material deposited on the substrate.
